(19) United States
(12) Patent Application Publication
(10) Pub. No.: US 2003/0198135 A1
(43) Pub. Date: Oct. 23, 2003

(54) Material temperature exposure timer apparatus and method

(76) Inventors: John S. Beatty, Altadena, CA (US); Robert D. Alfeld, Huntington Beach, CA (US); Michael William Busher, Huntington Beach, CA (US)

Correspondence Address: HARNESS, DICKEY & PIERCE, P.L.C., P.O. BOX 828, BLOOMFIELD HILLS, MI, 48303, US

(21) Appl. No.: 10/126,259

(22) Filed: Apr. 19, 2002

(51) Int. Cl. G01K 3/00; G04B 47/00

(52) U.S. Cl. 368/10; 374/104

(57) ABSTRACT

A temperature monitoring system and method for continuously monitoring the temperature of a material and providing a cumulative total time that the material has spent at a temperature above a predetermined temperature threshold over a given period of time or over the shelf life of the material. The apparatus 10 includes a temperature probe which provides an output to a temperature switch. The temperature switch provides an output therefrom to a cascaded counter array. An oscillator also provides an output to the counter array. The counter array maintains a cumulative count (i.e., cumulative time value) that the material has spent above a predetermined maximum temperature threshold. A battery powers the components of the apparatus and a display allows the user to display the cumulative time that the material has spent above the predetermined temperature threshold.

### FIELD OF THE INVENTION

This invention relates to timer systems, and more particularly to a material temperature exposure timer apparatus for measuring the cumulative time that a raw material spends above a predetermined temperature threshold and providing an indication of such cumulative time to a display or other device.

### BACKGROUND OF THE INVENTION

In many aerospace manufacturing applications involving catalyzed composite materials, it is critical to monitor the storage temperature of the materials. An example of such a material that is temperature sensitive is a graphite epoxy prepreg. Many such materials are both expensive and mission critical. Such materials frequently have strict limitations on the exposure time above certain temperatures (termed “out time”) that the material can experience before the quality or grade of the material can be adversely affected. Accordingly, it is important with such materials that the temperature thereof is monitored for the entire storage life of the material.

Present day temperature sensing systems rely on sealed strip recorders for recording the temperature of the material during transit. Once the material has arrived at a given destination freezer, then chart recorders on the freezer are used to monitor material storage conditions. Any time the material is subsequently transported between freezers, no such temperature measurements are performed. The temperature monitoring capability of the strip recorders presently used is also limited to a maximum of eight days. The limited measuring duration, limited sampling of shipments, and discontinuous storage history associated with present day temperature recording apparatuses and methods can seriously jeopardize the confidence in the quality of many catalyzed raw materials. Not only are such materials expensive and mission critical, but they can also have a long lead time for acquisition. Replacing material can cause serious adverse scheduling complications during a manufacturing operation should it be discovered that a given piece of catalyzed material has been (or may have been) adversely affected because of having spent too much time above a predetermined temperature threshold while being transported between freezers.

Accordingly, it is a principal object of the present invention to provide a temperature monitoring system and method for monitoring the total (i.e., cumulative) time duration at which a given material spends above a predetermined temperature threshold, for the entire storage life of the material. In this matter the quality of various types of temperature sensitive raw materials can be better insured.

### SUMMARY OF THE INVENTION

The present invention is directed to a temperature monitoring system and method for monitoring a cumulative time that a temperature of a raw material has exceeded a predetermined temperature threshold over the storage life of the material. The system may be removably secured directly to the raw material by any suitable means, or may be positioned in close proximity to the raw material on or within a shipping container of the raw material.

The system generally includes a temperature probe for continuously measuring a temperature of the raw material. A clock circuit is used for generating a clock signal. A switch responsive to the temperature probe is used for providing an output signal that indicates whenever the temperature of the raw material, as sensed by the temperature probe, is above a predetermined temperature threshold. A counter responsive to the output of the switch and to the clock circuit is used to maintain a cumulative time that the temperature of the material has exceeded the predetermined temperature threshold.

In a preferred embodiment the system comprises a battery for powering the various components thereof. The battery is preferably a long life battery able to operate at temperatures of −15F°. In one preferred embodiment a display driver and a display device are incorporated for providing a display of the cumulative time that the temperature of the material has spent above the predetermined threshold temperature.

The preferred embodiments all provide a temperature monitoring system that is self powered and which can accurately maintain a cumulative time that a raw material has exceeded a critical, predetermined temperature threshold. In this manner, an accurate determination can be made if a given piece of raw material has been compromised in terms of quality or grade because of excess exposure to temperatures which adversely affect its quality and/or grade. The temperature monitoring system of the present invention can be constructed relatively inexpensively and from a relatively few number of independent component parts. Thus, the system of the present invention forms a relatively compact, lightweight, inexpensive and reliable means for monitoring the temperature of materials for which an accurate determination must be made to how much time such materials have spent above the given predetermined temperature threshold.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified view of an apparatus in accordance with a preferred embodiment of the present invention disposed closely adjacent a roll of temperature sensitive raw material; and

FIG. 2 is a block diagram of the internal components of the temperature monitoring apparatus shown in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

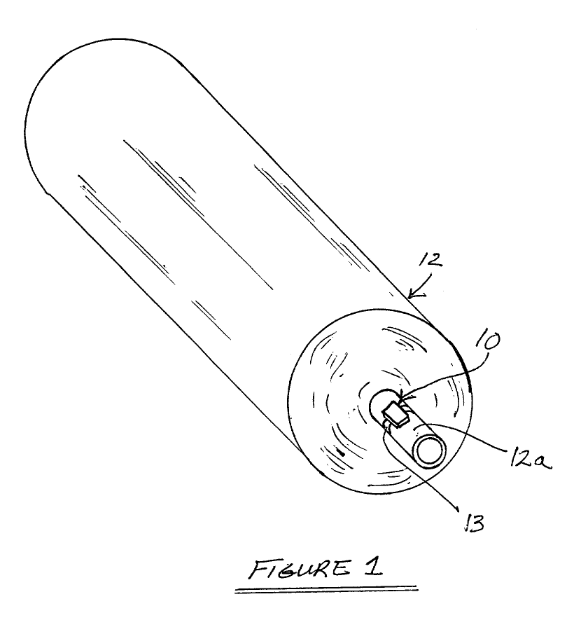

Referring to FIG. 1, there is shown a temperature monitoring apparatus 10 in accordance with a preferred embodiment of the present invention. The apparatus 10 is shown positioned closely adjacent a roll of raw material 12, such as on a center support tube 12a. Material 12 may comprise a raw material such as graphite epoxy prepreg or any other form or raw material that requires that its temperature be maintained below a predetermined minimum temperature threshold to ensure that the quality of the raw material 12 is not compromised. The system 10 may be secured to the center support tube 12a by any suitable means, for example double sided tape 13. Alternatively, the system could be secured inside the center support tube 12a. The system 10 is sufficiently compact and lightweight that it could also be secured directly to a cut off section of raw material.

It is a principal advantage of the apparatus 10 of the present invention that the apparatus is able to maintain a cumulative (i.e., running) time that the raw material 12 spends above the predetermined temperature threshold (i.e., termed its “out time”). In this manner an accurate assessment can be made as to whether the raw material has been comprised before using the material in a manufacturing process. In this regard, it will be appreciated that the material 12 is often stored in a freezer during shipment or is kept cool by dry ice during shipment. Typically the material 12 is kept in a freezer at a manufacturing facility until it is needed in a manufacturing process. However, for those times that the material is being transported between freezers, the material 12 will not be refrigerated and will typically rise towards the temperature of its ambient environment. For those time periods, it is critically important to keep track of the cumulative time that the material 12 spends above the predetermined temperature threshold.

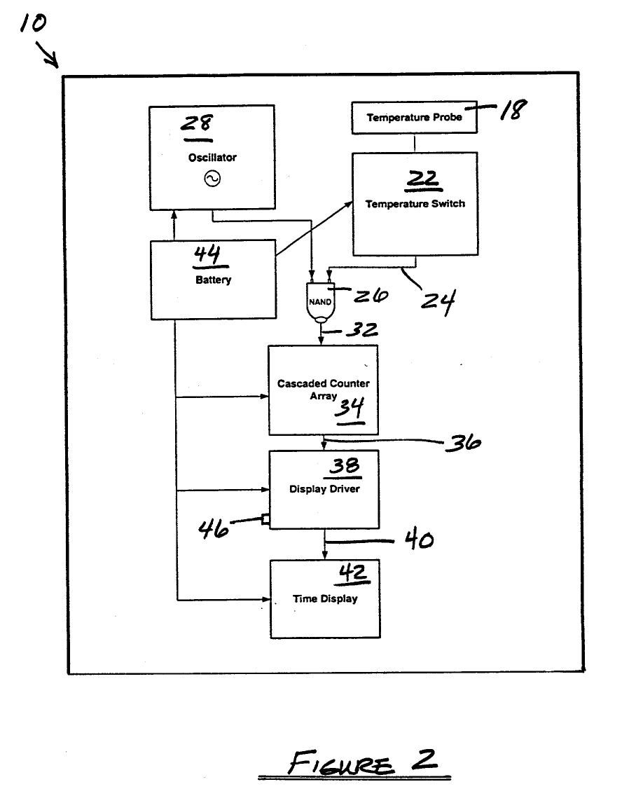

Referring to FIG. 2, the apparatus 10 generally includes a temperature sensing probe 18 which provides an output 20 to a temperature switch 22. The temperature switch 22 comprises a comparator having an output which changes state when the output 20 of the probe 18 (coupled to an input of the comparator) reaches a predetermined threshold. The temperature switch 22 generates an output 24 to a NAND-gate 26. An oscillator 28 is used to generate a clock signal via output 30 which is also applied to an input of the NAND-gate 26. An output 32 of the NAND-gate 26 is provided to a cascaded counter array 34. The cascaded counter array 34 in turn provides an output 36 to a display driver circuit 38, which in turn provides an output 40 to a display device 42. The display device 42 may comprise any form of visual display such as a liquid crystal display (LCD), light emitting diode (LED) display, etc. A battery 44 provides power to the counter array 34, the display driver 38, the time display 42, the oscillator 28 and the temperature switch 22. The apparatus 10 thus forms a fully self-powered device.

The battery 44 is preferably a lithium ion battery capable of operating down to temperatures of −15F° for several months. The oscillator 28 may comprise a conventional 555 timer circuit or any other suitable oscillator circuit for generating the needed clock signal. An alternative implementation of the apparatus 10 could just as easily involve a connection between the temperature switch 22 and the oscillator 28 such that the oscillator 28 is only turned on when the temperature switch 22 provides a certain output indicating that the temperature of the material 12 has risen beyond the predetermined temperature threshold.

The temperature probe 18 comprises a calibrated temperature measurement device with suitable sensitivity at temperatures well below freezing. In one preferred form the temperature probe 18 comprises a thermistor. It will be appreciated, however, that other suitable temperature sensing technologies could be employed just as readily.

The temperature switch 22 operates to monitor the output of the temperature probe 18 and to provide either a first output or a second output. The first output is provided when the output of the temperature probe 18 is indicating that the temperature of the raw material 12 is below the predetermined threshold temperature. The second output is provided when the temperature of the raw material 12 has risen beyond the predetermined temperature threshold. The cascaded counter array 34 maintains a running time tally (i.e., cumulative time) that the temperature probe 18 has sensed the temperature of the raw material 12 to be above the predetermined threshold temperature. In one preferred form the cascaded counter array 34 comprises one conventional counter chip for each digit of the timer.

The display driver 38 is used to convert the output from the cascaded counter array 34, which comprises a binary output, to an output compatible with the display 42. The display 42 comprises a multi-digit display that indicates the exposure time of the raw material 12 above the predetermined threshold temperature. It will be appreciated that the display 42 must be able to operate at very low temperatures (i.e., well below freezing). The display driver 38 may alternatively comprise a momentary contact switch 46 that allows the user to activate the display 42 and show the cumulative time that the material 12 has spent above the predetermined threshold temperature. In one preferred form, the time display 42 comprises a 7-segment LED display. However, to conserve battery power, it may be desirable in some applications to make use of a LCD system rather than an LED system.

The apparatus 10 of the present invention thus forms a means by which the cumulative time that a material spends above a predetermined temperature threshold can be continuously monitored and displayed to a user. In this manner, the quality and/or strength of the material can be reliably ensured. The apparatus 10 forms a relatively simple, inexpensive means for continuously monitoring the temperature of a given piece of material or quantity of material. Since the apparatus 10 is formed from a relatively small number of independent component parts, reliability of the apparatus is enhanced while allowing the apparatus 10 to be very cost effectively constructed.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A temperature monitoring system for monitoring a cumulative time that a temperature of a material has exceeded a predetermined temperature threshold over a given time period, said system comprising:
a temperature probe for continuously measuring a temperature of said material;
a clock for generating a clock signal;
a switch responsive to said temperature probe, said switch providing a first output when said temperature probe is indicating that said temperature of said material does not exceed said predetermined temperature, and a second output when said switch is indicating when said temperature of said material has exceeded said predetermined threshold temperature; and
a counter responsive to said switch output and to said clock signal for maintaining a cumulative time that said temperature of said material has exceeded said predetermined temperature.

2. The system of claim 1, further comprising a battery for powering said timing circuit and said counter.

3. The system of claim 1, further comprising a display responsive to said counter for providing a display of said cumulative time that said temperature of said material has exceeded said predetermined threshold.

4. The system of claim 3, further comprising a display driver circuit for receiving an output from said counter and generating a output to said display to drive said display.

5. The system of claim 1, further comprising a logic gate responsive to said clock signal and said output of said switch for generating a logic level output signal to an input of said counter, to thereby turn on and off said counter.

6. A temperature monitoring system for monitoring a cumulative time that a temperature of a raw material has is not within a predetermined temperature threshold over a given time period, said system comprising:
a temperature sensor for continuously measuring a temperature of said material;
a clock circuit for generating a clock signal;
a switch responsive to said temperature sensor, said switch providing a first output when said temperature sensor is indicating that said temperature of said material is within said predetermined temperature threshold, and a second output when said temperature sensor is indicating when said temperature of said material is outside of said predetermined temperature threshold; and
a counter responsive to said switch output and to said clock signal for maintaining a cumulative time that said temperature of said material is outside of said predetermined threshold; and
a battery for powering said clock circuit and said temperature sensor.

7. The system of claim 6, wherein said clock circuit comprises an oscillator.

8. The system of claim 6, wherein said clock circuit is responsive to said switch output such that said clock circuit is turned on only when said switch is generating said second output.

9. The system of claim 6, further comprising a logic gate responsive to said clock circuit and said switch for generating an output for driving said counter when said temperature sensor is indicating that said temperature of said material is outside of said predetermined threshold.

10. The system of claim 6, further comprising a display for displaying said cumulative time.

11. The system of claim 10, further comprising a display driver responsive to an output of said counter circuit for generating a drive signal for driving said display.

12. The system of claim 6, wherein said counter circuit comprises a cascaded counter array.

13. A method for monitoring a cumulative time that a temperature of a material has exceeded a predetermined temperature threshold over a given time period, said method comprising:
using a temperature sensor to continuously sense a temperature of said material;
using a clock circuit to generate a clock signal;
using a switch responsive to an output of said temperature sensor to generate an output indicating when a temperature of said material has crossed a predetermined temperature threshold; and
using a counter responsive to said output of said switch to record a length of each time duration that said switch is indicating that said temperature of said material has crossed said predetermined temperature threshold, to thereby maintain a cumulative time total that said material has spent above said predetermined temperature threshold.
